(19) United States
(12) Patent Application Publication
(10) Pub. No.: US 2017/0277324 A1
(43) Pub. Date: Sep. 28, 2017

(54) TOUCH SENSOR FOR TOUCH SCREEN PANEL AND MANUFACTURING METHOD THEREFOR

(71) Applicant: AMOSENSE CO., LTD., Chungcheongnam-do (KR)

(72) Inventors: Sung-Baek DAN, Gyeonggi-do (KR); Jin-Su HWANG, Gyeonggi-do (KR)

(21) Appl. No.: 15/508,641

(22) PCT Filed: Sep. 4, 2015
(86) PCT No.: PCT/KR2015/009367

§ 371 Date: Apr. 4, 2017

(30) Foreign Application Priority Data
Sep. 5, 2014 (KR) 10-2014-0118748

(51) Int. Cl. G06F 3/041; G06F 3/044

(52) U.S. Cl. CPC G06F 3/0412; G06F 3/044; G06F 2203/04103; G06F 2203/04104

(57) ABSTRACT

The present invention relates to a touch sensor for a touch screen panel, a method for manufacturing the touch sensor, and a touch screen panel including the touch sensor. The method includes: forming an electrode layer on a transparent substrate; forming a nanofiber layer on the electrode layer through electrospinning; and forming a porous electrode layer by etching the electrode layer using the nanofiber layer as an etching mask. Through this method, a touch sensor including a touch sensing circuit pattern provided with a plurality of exposure pores to expose the transparent substrate therethough is produced. Due to the pores formed in the touch sensing circuit pattern, visibility is ensured and durability and flexibility are improved. Furthermore, due to irregularity of line patterns of the touch sensing circuit pattern, a moire problem is solved and visibility of a touch screen panel is dramatically improved.

### TECHNICAL FIELD

The present invention relates to a touch sensor for a touch screen panel. More particularly, it relates to a touch sensor for a touch screen panel ensuring long term durability and excellent visibility and flexibility, and a method for manufacturing the touch sensor.

The present application claims priority to Korean Patent Application No. 10-2014-0118748, filed Sep. 5, 2014, the entire contents of which is incorporated herein for all purposes by this reference.

### BACKGROUND ART

Typically, a touch screen panel is manufactured by combining a touch sensor, consisting of a transparent film and a transparent electrode, with a cover glass.

A conventional touch sensor is manufactured by forming an electrode material, for example, Indium Tin Oxide (ITO), on a transparent film and etching the electrode material into a sensing electrode.

With reference to FIG. 1, a touch screen panel 1 has a structure in which two touch sensors 1c and a reinforced glass plate 1d are sequentially stacked up in this order on a display panel 1a and the stacked layers are bonded to each other via respective transparent adhesive layers 1b.

A typical touch screen panel is mainly of a GFF type consisting of a reinforced glass plate 1d and two touch sensors, each touch sensor including an ITO sensing electrode formed on a film substrate. The two touch sensors respectively serve as an X axis sensor and Y axis sensor.

However, this conventional touch sensor for a touch screen panel, consisting of an ITO sensing electrode formed on a film substrate, suffered touch response degradation due to high resistance of the ITO sensing electrode and thus was difficult to offer multi-touch implementation for a screen having a 13-inch or larger size.

In addition, indium, which is a main component of the Indium Tin Oxide (ITO) electrode, is a rare earth metal in danger of running out, and is thus expensive due to the limited reserves, which undesirably increases the manufacturing cost of a touch screen panel.

In addition, since an Indium Tin Oxide (ITO) electrode is processed at a high temperature, it is difficult to form an ITO electrode on a flexible substrate. Furthermore, an ITO electrode easily cracks due to its weak mechanical strength. Therefore, an ITO electrode is unsuitable for use in a flexible display device.

In addition, waste water is discharged during a dry etching process of an ITO electrode, which leads to environmental pollution. In addition, there is a problem that indium is likely to diffuse into an organic layer when a touch sensor is applied to an organic light-emitting diode (OLED) display device.

Furthermore, an ITO electrode consumes an excessively large amount of electric power due to its high resistance when it is applied to a 13-inch or larger touch screen panel.

Alternatively, a touch sensor can be manufactured by forming a silver nanowire (AgNW) on the entire area of a transparent film and etching the silver nanowire to produce a transparent electrode. A transparent electrode made of silver nanowire (AgNW) exhibits low resistance, thereby offering high touch response. However, this electrode has a problem of low transparency.

In addition, according to a manufacturing method of a conventional touch sensor, a transparent film usually undergoes exposing, developing, and etching. The transparent film is damaged, i.e. scratched, through these processes. For this reason, optical characteristics of a touch screen panel are deteriorated.

In addition, since a conventional touch screen panel includes two touch sensors 1c serving as an X axis sensor and a Y axis sensor, each sensor being formed on a transparent film, the conventional touch sensor is problematic in terms of the complicated manufacturing method and high manufacturing cost. Furthermore, there is a limit in reducing the thickness of a touch screen panel.

In addition, recent touch sensors use silver nanowire electrodes or metal mesh electrodes instead of indium tin oxide (ITO) electrodes.

Although silver nanowire electrodes are advantageous in terms of flexibility, they are problematic in that conductivity is deteriorated due to contact resistance of nanowires superimposed on each other and operation reliability is deteriorated due to a yellowing phenomenon after a long term use.

Meanwhile, metal mesh electrodes are advantageous in terms of flexibility and conductivity, but they have a problem of offering poor visibility attributable to Moiré effect.

### DISCLOSURE

### Technical Problem

Accordingly, the present invention has been made keeping in mind the above problems occurring in the prior art, and an object of the present invention is to provide a touch sensor for a touch screen panel, the touch sensor offering high operation reliability required for a touch screen panel through stable touch response speed and multi-touch implementation, as well as having high transparency, durability, and flexibility. Another object of the present invention is to provide a method for manufacturing the touch sensor. A further object of the invention is to provide a touch screen panel including the touch sensor.

### Technical Solution

In order to accomplish the objects of the present invention, there is provided a touch sensor for a touch screen panel, the sensor including a transparent substrate and a touch sensing circuit pattern provided on the transparent substrate and configured to sense a touch operation applied to a touch screen panel, the touch sensing circuit pattern including a porous electrode layer provided with a plurality of pores.

In the present invention, the touch sensing circuit pattern includes a line pattern with a line width not greater than 15 μm, and the pores are formed within the line pattern.

In the present invention, the touch sensing circuit pattern may include a nanowall having a width of 50 to 3000 nm and serving as a boundary member for defining the pores.

In the present invention, the nanowalls are electrically connected to each other by being arranged to intersect each other, and the nanowalls are in the form of an irregular mesh.

The touch sensing circuit pattern may further include an anti-reflection reflection layer or an adhesion-enhancing layer stacked on the porous electrode layer and provided with a plurality of holes communicating with the pores of the porous electrode layer.

In order to accomplish the objects of the present invention, there is provided a method for manufacturing a touch sensor for a touch screen panel, the method including: forming an electrode layer on a transparent substrate; forming a nanofiber layer on the electrode layer through an electrospinning process; and etching a portion of the electrode layer uncovered by the nanofiber layer serving as an etching mask, thereby forming a porous electrode layer.

In the present invention, in the forming of the electrode layer, the electrode layer is formed through a vacuum deposition process.

In the present invention, in the forming of the nanofiber layer, nanofiber with a diameter of 50 to 3000 nm is formed on the electrode layer using an electrospinning process.

In the present invention, in the forming of the nanofiber layer, the electrospinning process is performed using a polymer spinning solution containing 5 to 20% by weight of a polymer resin and 80 to 95% by weight of a solvent.

In the present invention, in the forming of the nanofiber layer, the electrospinning process is performed using a polymer spinning solution containing 5 to 20% by weight of a polymer resin and 80 to 95% by weight of a solvent, or a polymer spinning solution containing 5 to 20% by weight of a polymer resin, 79.5 to 94.5% by weight of a solvent, and 0.5 to 4% by weight of a resin adhesive or a surfactant.

In the present invention, as the polymer resin, polyvinylidene fluoride (PVDF), polystyrene (PS), poly(methylmethacrylate)(PMMA), and polyacrylonitrile (PAN) are used singly or in combination.

The method for manufacturing a touch sensor for a touch screen panel according to one embodiment of the present invention may further include curing the nanofiber layer by heating the nanofiber layer.

The curing may further include a process of pressing the nanofiber layer.

The method for manufacturing a touch sensor for a touch screen panel according to one embodiment of the present invention may further include forming a touch sensing circuit pattern by etching the porous electrode layer.

### Advantageous Effects

According to the present invention, the pores of the circuit pattern have an effect of improving visibility, durability, and flexibility of a touch screen panel.

Irregularity of the pattern line of the circuit pattern solves the Moiré problem, thereby dramatically improving visibility of a touch screen panel.

High conductivity, durability, and flexibility of the circuit pattern have an effect of improving operational reliability of products.

### DESCRIPTION OF DRAWINGS

FIG. 1 is a diagram illustrating a touch screen panel according to a conventional art;

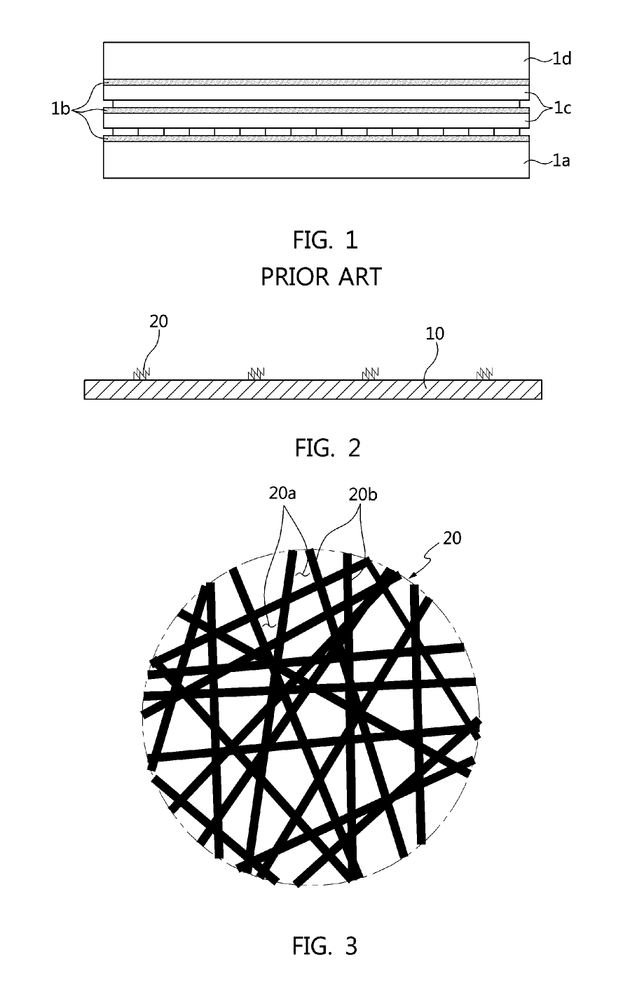

FIG. 2 is a cross-sectional view illustrating a touch sensor for a touch screen panel according to one embodiment of the present invention;

FIG. 3 is an enlarged plan view illustrating a touch sensing circuit pattern of the touch sensor for a touch screen panel according to one embodiment of the present invention;

FIG. 4 is a plan view illustrating the touch sensor for a touch screen panel according to one embodiment of the present invention;

FIG. 5 is a perspective view illustrating the touch sensor for a touch screen panel according to one embodiment of the present invention;

FIGS. 6 and 7 are cross-sectional views illustrating a touch sensor for a touch screen panel according to another embodiment of the present invention;

FIGS. 8 to 12 are schematic views illustrating touch screen panels according to embodiments of the present invention;

FIG. 13 is a flowchart illustrating a method for manufacturing a touch sensor for a touch screen panel according to one embodiment of the present invention;

FIGS. 14 and 15 are schematic views illustrating the method for manufacturing a touch sensor for a touch screen panel of FIG. 13 according to one embodiment of the present invention; and

FIGS. 16 to 19 are enlarged photographs illustrating a nanofiber layer that is formed thorough a nanofiber layer forming process of the present invention.

### DESCRIPTION OF THE REFERENCE NUMERALS IN THE DRAWINGS

2: Electrode layer 3: Nanofiber layer

10: Transparent substrate 11: Touch screen panel cover substrate

12: First transparent substrate 13: Second transparent substrate

20: Touch sensing circuit pattern 20a: Pore

20b: Nanowall 21: X axis sensing circuit portion

22: Y axis sensing circuit portion 30: Display panel unit

40: Transparent adhesive layer

### Mode for Invention

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

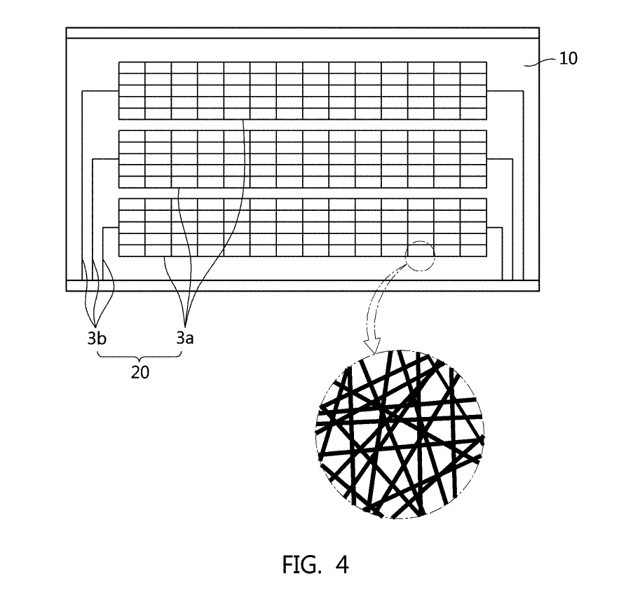

In FIGS. 2 to 15, line widths, intervals or pitches of pattern lines of a touch sensing circuit pattern 20 are schematically illustrated or enlarged to give a clearer description of the construction of the present invention and thus may be different from real scales.

For reduction to practice of a touch sensor for a touch screen panel according to the present invention, it should be confirmed that variable modifications are possible such that a touch sensing circuit pattern 20 in a real touch screen has a fine line width and interval that ensures a transparency whereby the touch sensing circuit pattern 20 is invisible.

FIG. 2 is a cross-sectional view illustrating a touch sensor according to one embodiment of the present invention. With reference to FIG. 2, according to one embodiment of the present invention, a touch sensor for a touch screen panel includes a transparent substrate 10 and a touch sensing circuit pattern 20 provided on the transparent substrate 10 and configured to sense a touch operation applied to a touch screen panel.

The transparent substrate 10 may be any one selected from the group consisting of a transparent polyimide (PI) film, a polyethylene naphthalate (PEN) film, a polyethylene terephthalate (PET) film, a polycarbonate (PC) film, and a poly styrene sulfonate (PSS) film. Alternatively, the transparent substrate 10 may be a transparent film such as an engineering plastic.

Further alternatively, the transparent substrate 10 may be a reinforced glass plate or a reinforced coated film prepared by forming a reinforced coating layer on the surface of a film substrate to increase the rigidity of the film substrate. The film substrate may be a transparent polyimide (PI) film, a polyethylene naphthalate (PEN) film, a polyethylene terephthalate (PET) film, a polycarbonate (PC) film, or a poly styrene sulfonate (PSS) film. Aside from these, the present invention can be modified such that the film substrate may be any synthetic resin film that can be coated with a reinforcing coating layer.

The reinforced coating layer may be a resin layer formed through a coating process using a resin containing silicon (Si) or ceramic, or a coating layer formed through a vacuum deposition process. Aside from these, the present invention can be modified such that any coating layer that can improve anti-scratching and anti-cracking properties by increasing the rigidity of the surface of the film substrate can be used as the reinforced coating layer.

The reinforced coating layer has a thickness of 0.3 mm or less so as to be flexible, whereby it can be applied to a flexible touch screen panel.

The transparent substrate 10 may be a touch screen panel cover substrate protecting the screen of a display panel unit of a touch screen panel, and the touch screen panel cover substrate is preferably the reinforced glass plate or the reinforced coated film.

The transparent substrate 10 is the touch screen panel cover substrate, and the touch sensing circuit pattern 20 is directly formed on a first surface of the touch screen panel cover substrate. Therefore, the thickness and weight of a touch screen panel can be reduced.

The first surface of the touch screen panel cover substrate is an inner surface in a touch screen panel, i.e. a surface facing a display panel unit. It is also a surface opposite to an outer surface in the touch screen panel, i.e. opposite to an exposed surface when the touch screen panel cover substrate is applied to the display panel unit.

The touch sensing circuit pattern 20 includes a porous electrode layer provided with a plurality of pores through which the transparent substrate 10 is exposed.

The pores are through-holes passing through a surface of the electrode layer on the transparent substrate 10.

Specifically, the touch sensing circuit pattern 20 is a line pattern with a line width of 15 μm or less or more preferably 3 μm or less. According to one embodiment, the porous electrode layer is a line pattern with a plurality of pores through which the transparent substrate 10 is exposed.

The touch sensing circuit pattern 20 includes the porous electrode layer. The touch sensing circuit pattern 20 may further include an anti-reflection layer or an adhesion-enhancing layer stacked on the porous electrode layer and provided with a plurality of holes communicating with the pores of the porous electrode layer.

The anti-reflection layer or the adhesion-enhancing layer may be provided on the porous electrode layer or between the porous electrode layer and the transparent substrate 10. That is, the anti-reflection layer and the porous electrode layer, or the adhesion-enhancing layer and the porous electrode layer may be sequentially stacked in this order on the transparent substrate 10. Alternatively, the porous electrode layer and the anti-reflection layer, or the porous electrode layer and the adhesion-enhancing layer may be stacked in this order.

The anti-reflection layer or the adhesion-enhancing layer may be provided with a plurality of holes communicating with the pores of the porous electrode layer.

The anti-reflection layer exhibits an optical reflectivity of 30% or lower, thereby minimizing light scattering, increasing optical transmittance, and preventing glaring. Thus the anti-reflection layer improves visibility of a touch screen panel.

The adhesion-enhancing layer is laminated on the transparent substrate 10, thereby enhancing the adhesion of the touch sensing circuit pattern 20 to the transparent substrate 10. Therefore, the touch sensing circuit pattern 20 can be firmly attached to the transparent substrate 10 even when the transparent substrate 10 is a flexible member and even while the touch sensing circuit pattern undergoes repetitive flexural deformations.

The touch sensing circuit pattern 20 can be made from only the electrode layer, from a combination of the electrode layer and the anti-reflection layer, or a combination of the adhesion-enhancing layer formed on the transparent substrate 10 and the electrode layer formed on the adhesion-enhancing layer.

Alternatively, the touch sensing circuit pattern 20 can be made from a combination of the adhesion-enhancing layer formed on the transparent substrate, and the electrode layer and the anti-reflection layer formed on the adhesion-enhancing layer.

The electrode layer may be made from a highly conductive material, such as gold, silver, aluminum, copper, and carbon nanotubes, or from an alloy containing at least one element selected from the group consisting of gold, silver, aluminum, copper, and carbon nanotubes. The electrode layer is formed to ensure the conductivity required for the touch sensing circuit pattern 20 and have allowable resistance.

The electrode layer is formed by depositing a conductive material such as gold, silver, aluminum, and copper, or carbon nanotubes. Alternatively, the electrode layer can be formed by printing a conductive paste containing conductive powder of gold, silver, aluminum, copper, or carbon nanotube on the transparent substrate 10 and drying or sintering.

The adhesion-enhancing layer or the anti-reflection layer may be a thin deposition film formed through a deposition process. The thin deposition film can be formed through a vacuum deposition process. The thin deposition film is made from, for example, chrome (Cr). Aside from chrome (Cr), the thin deposition film can be made from any one selected from the group consisting of molybdenum (Mo), titanium (Ti), tungsten (W), nickel-chrome (NiCr), titanium-tungsten (TiW), and copper (Cu). Alternatively, the thin deposition film can be made from an alloy of at least two metals selected from the group consisting of molybdenum (Mo), titanium (Ti), tungsten (W), nickel-chrome (NiCr), titanium-tungsten (TiW), and copper (Cu). Further alternatively, the thin deposition film can be made from an alloy containing at least one metal selected from the group consisting of molybdenum (Mo), titanium (Ti), tungsten (W), nickel-chrome (NiCr), titanium-tungsten (TiW), and copper (Cu). The thin deposition film is desirably made from a metal that has high adhesion to a touch screen panel substrate 1 and can minimize scattering of light.

Since the thin deposition film is formed on the transparent substrate 10 through a vacuum deposition process, it is firmly adhered to the transparent substrate 10. Therefore, the thin deposition film is not easily separated from the transparent substrate 10 even when it undergoes flexural deformation. That is, the thin deposition film remains firmly attached to the transparent substrate 10.

The thin deposition film is preferably formed by thermal evaporation of copper (Cu). Copper (Cu) is a common plating material, exhibits high adhesion to the electrode layer, and becomes black when deposited.

The adhesion-enhancing layer or the anti-reflection layer can be formed using a conductive ink or a conductive paste.

Preferably, a black ink or paste is used as the conductive ink or the conductive paste to form the electrode layer, thereby reducing diffused reflection.

According to one example, the conductive ink or the conductive paste contains conductive powder and a black darkening agent. The conductive powder may be silver powder, copper powder, gold powder, or aluminum powder. The conductive ink or conductive paste contains at least one kind of conductive powder having a high conductivity. The conductive ink or conductive paste may contain a mixture of two kinds of conductive powder.

Examples of the darkening agent include carbon black and carbon nanotubes. Any black darkening agent can be used for the conductive ink or conductive paste, and among them, a material with a higher conductivity is more preferably used.

The conductive ink or conductive paste may contain carbon black or carbon nanotubes therein.

For example, the adhesion-enhancing layer or the anti-reflection layer is formed by drying or sintering the conductive ink or conductive paste. Sintering of the conductive ink or conductive paste during formation of the adhesion-enhancing layer or anti-reflection layer has effects of reducing resistance and enhancing adhesion to the transparent substrate 10.

A dark metal capable of absorbing light is preferably used to form the adhesion-enhancing layer or the anti-reflection layer. More preferably, a black metal or a metal that exhibits a reflectivity of 30% or less when deposited is used.

The anti-reflection layer has a reflectivity of 30% or less, thereby minimizing optical scattering to improve optical transmittance and preventing glaring to improve visibility of a touch screen panel.

The adhesion-enhancing layer or the anti-reflection layer preferably has a thickness of 500 to 10,000 Å. In one embodiment of the present invention, the thickness is 1000 Å.

The touch sensing circuit pattern 20 has a shape by which a touch operation can be detected.

The touch sensing circuit pattern may include the porous electrode layer and the anti-reflection layer or adhesion-enhancing layer, and may be formed as a line pattern with a line width of 15 μm. Preferably, the line width may be 3 μm or less. In one embodiment of the present invention, the surface of the transparent substrate 10 can be exposed through the pores of the porous electrode layer and the holes of the anti-reflection layer or the adhesion-enhancing layer.

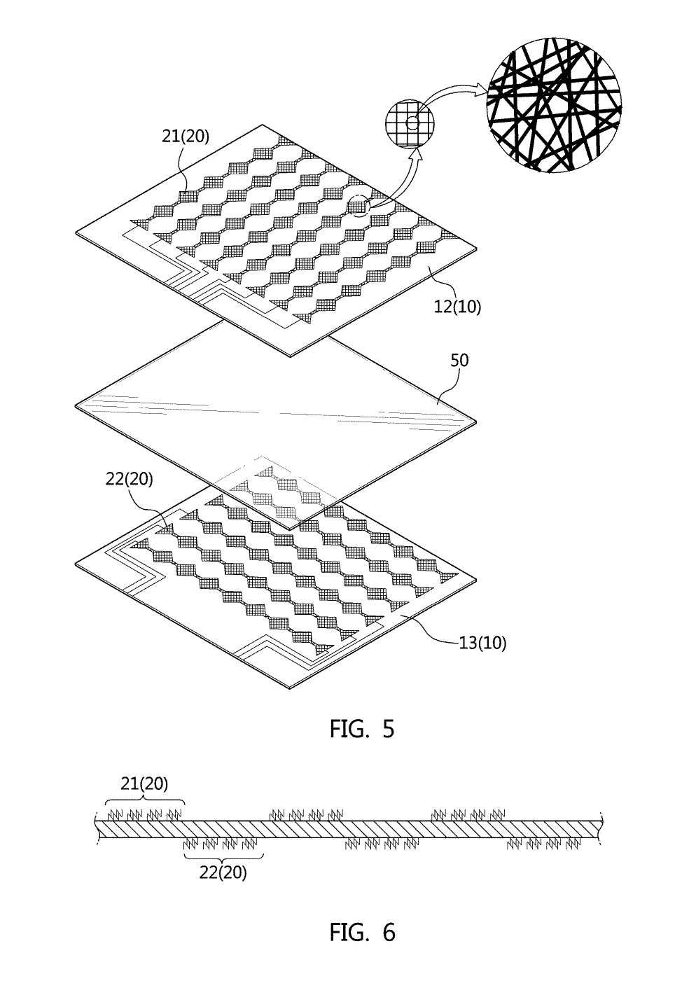

FIG. 3 is a plan view illustrating the touch sensing circuit pattern in an enlarged manner. With reference to FIG. 3, the touch sensing circuit pattern includes nanowalls 20b serving as boundary members between pores 20a. The nanowalls 20b have an irregular mesh form and have a line width of 50 to 3000 nm.

The nanowalls 20 are electrically connected to each other by being arranged to intersect each other, and define the pores 20a therebetween.

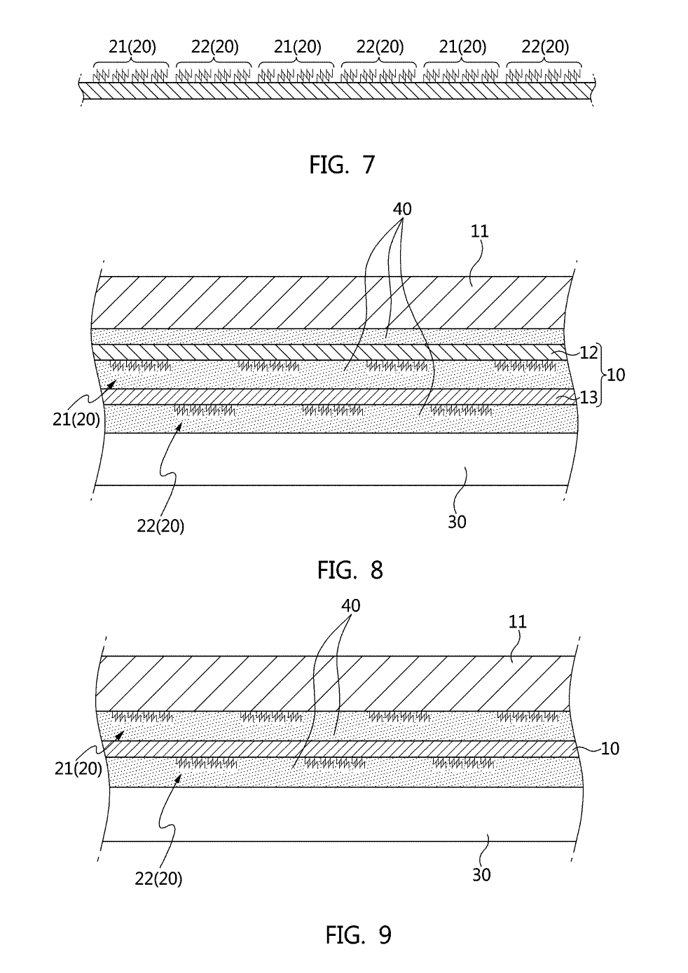

FIG. 4 is a plan view illustrating a touch sensor for a touch screen panel according to one embodiment of the present invention.

With reference to FIG. 4, the touch sensing circuit pattern 20 includes a sensing circuit portion 3a for detecting a touch operation and a tracing circuit portion 3b for connecting the sensing circuit portion to an external control chip.

The touch sensing circuit pattern 20 is preliminarily designed according to the size and usage of a touch screen. The touch sensing circuit pattern 20 can be designed in various patterns. The sensing circuit portion 3a has a mesh form to detect multi-touch operations, thereby being helpful in implementing a precise touch sensor.

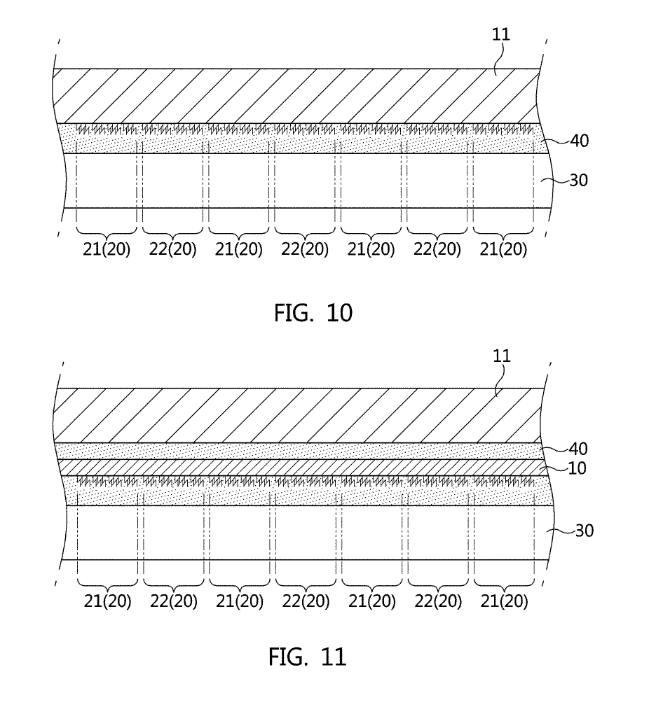

With reference to FIG. 5, the touch sensing circuit pattern 20 has a circuit shape by which a touch operation can be detected. The touch sensing circuit pattern 20 includes an X axis sensing circuit portion 21 including a plurality of X axis electrodes spaced from each other in a horizontal direction and a Y axis sensing circuit portion 22 including a plurality of Y axis electrodes spaced from each other in a vertical direction.

The transparent substrate 10 includes a first transparent substrate 12 and a second transparent substrate 13. The touch sensing circuit pattern 20 includes the X axis sensing circuit portion 21 provided on the first transparent substrate 12 and including the X axis electrodes spaced from each other in the horizontal direction and the Y axis sensing circuit portion 22 provided on the second transparent substrate 13 and including the Y axis electrodes spaced from each other in the vertical direction.

The X axis electrodes spaced from each other in the horizontal direction and the Y axis electrodes spaced from each other in the vertical direction are connected to an external circuit via tracing electrodes. For example, the external circuit is a capacitive multi-touch controller, and the capacitive multi-touch controller is electrically connected to a main processor of an electronic device.

The X axis electrodes and the Y axis electrodes have a rhombus-shaped metal mesh form. The X axis sensing circuit portion 21 includes a plurality of X axis electrodes having a rhombus-shaped metal mesh form and electrically connected to each other and the Y axis sensing circuit portion 22 includes a plurality of Y axis electrodes having a rhombus-shaped metal mesh form and electrically connected to each other.

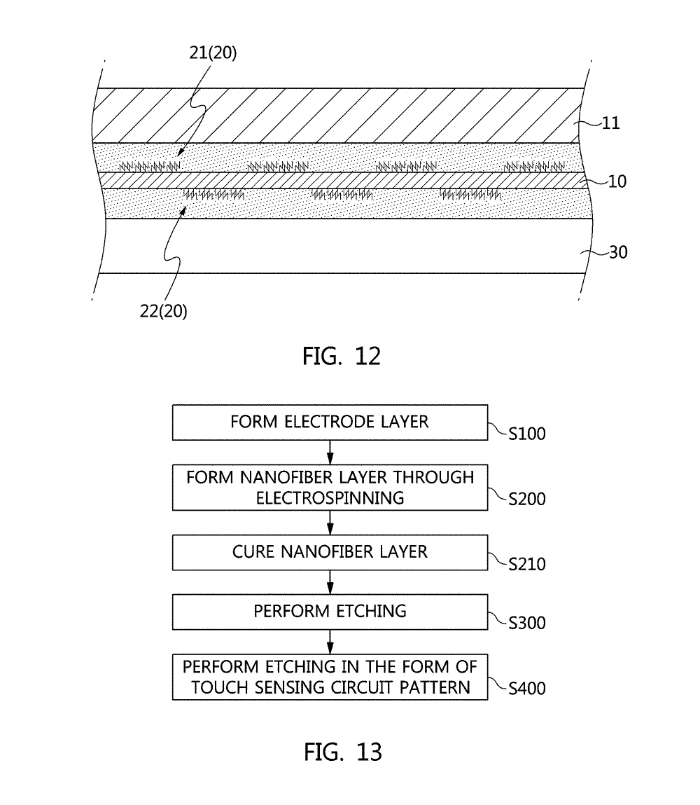

With reference to FIG. 6, according to one embodiment of the present invention, the touch sensing circuit pattern 20 includes an X axis sensing circuit portion 21 provided on one surface of the transparent substrate 10 and including a plurality of X axis electrodes spaced from each other in the horizontal direction and an Y axis sensing circuit portion 22 provided on the other surface of the transparent substrate 10 and including a plurality of Y axis electrodes spaced from each other in the vertical direction.

Since the X axis sensing circuit portion 21 and the Y axis sensing circuit portion 22 are provided on the respective surfaces of the transparent substrate 10, the raw material cost of a touch screen panel can be reduced, and a slimmer and lighter touch screen panel can be provided.

With reference to FIG. 7, as to the touch sensing circuit pattern 20, the X axis sensing circuit portion 21 including the X axis electrodes spaced from each other in the horizontal direction, and the Y axis sensing circuit portion 22 including the Y axis electrodes spaced from each other in the vertical direction can be formed on the same surface of the transparent substrate 10.

Since the X axis sensing circuit portion 21 and the Y axis sensing circuit portion 22 are formed on one principle surface of the transparent substrate 10, the raw material cost of a touch screen panel can be reduced and a touch screen panel that is slimmer and lighter and has improved optical characteristics can be provided.

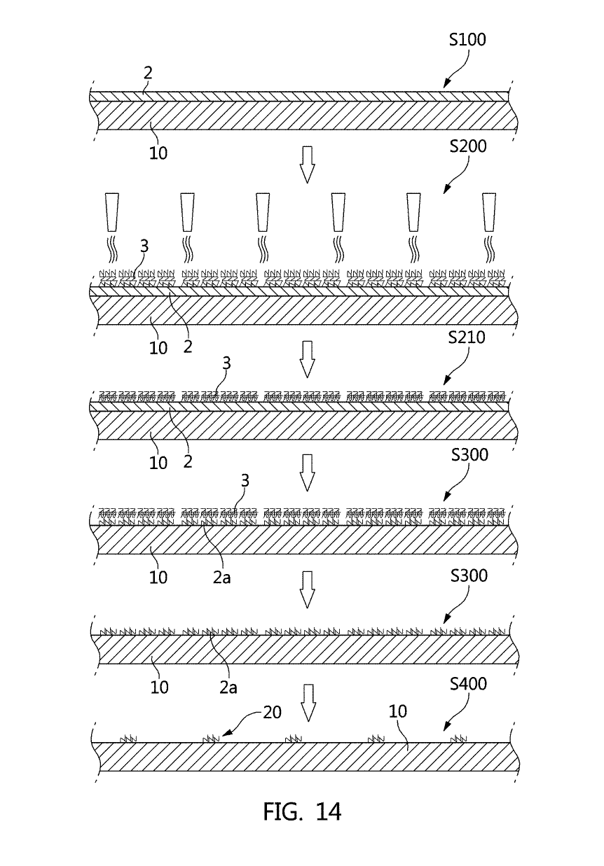

With reference to FIGS. 8 to 12, according to one embodiment of the present invention, a touch screen panel includes a display panel unit 30 with a screen portion for displaying an image, a touch screen panel cover substrate 11 for covering and protecting the screen portion of the display panel unit 30, and a touch sensing circuit pattern 20 provided between the display panel unit 30 and the touch screen panel cover substrate 11 to detect a touch operation on the touch screen panel.

The touch screen panel cover substrate 11 may be a reinforced glass plate which is a transparent substrate 10 or a reinforced coated film that includes a film substrate and a reinforced coating layer formed on the surface of the film substrate to increase the rigidity of the film substrate.

Specifically, with reference to FIG. 8, the touch screen panel according to one embodiment of the present invention further includes a first transparent substrate 12 and a second transparent substrate 13 both of which are interposed between the display panel unit 30 and the touch screen panel cover substrate 11 and spaced from each other. The touch sensing circuit pattern 20 includes an X axis sensing circuit portion 21 provided on the first transparent substrate 12 and including a plurality of X axis electrodes spaced from each other in a horizontal direction and an Y axis sensing circuit portion 22 provided on the second transparent substrate 13 and including a plurality of Y axis electrodes spaced from each other in a vertical direction.

The display panel unit 30, the touch screen panel cover substrate 11, and the first and second transparent substrates 12 and 13 arranged between the display panel unit 30 and the touch screen panel cover substrate 11 are bonded to each other via transparent adhesive layers 40. An example of the transparent adhesive layers 40 may be an optically clear adhesive (OCA) film.

The transparent adhesive layers 40 are provided between the touch screen panel cover substrate 11 and the first transparent substrate 12, between the first transparent substrate 12 and the second transparent substrate 13, and between the display panel unit 30 and the second transparent substrate 13, respectively.

With reference to FIG. 9, the touch screen panel according to one embodiment of the present invention further includes a transparent substrate 10 spaced from the touch screen panel cover substrate 11. The touch sensing circuit pattern 20 includes: an X axis sensing circuit portion 21 provided to either one of the touch screen panel cover substrate 11 and the transparent substrate 10 and including a plurality of X axis electrodes spaced from each other in the horizontal direction; and an Y axis sensing circuit portion 22 provided to the other one of the touch screen panel cover substrate 11 and the transparent substrate 10 and including a plurality of Y electrodes spaced from each other in the vertical direction.

One surface of the touch screen panel is provided with either one of the X axis sensing circuit portion 21 and the Y axis sensing circuit portion 22, and one surface of the transparent substrate 10 is provided with the other one of the X axis sensing circuit portion 21 and the Y axis sensing circuit portion 22.

The display panel unit 30, the touch screen panel cover 11, and the transparent substrate 10 arranged between the display panel unit 30 and the touch screen panel cover substrate 11 are bonded to each other via respective transparent adhesive layers 40. An example of the transparent adhesive layers 40 may be an optically clear adhesive (OCA) film.

The respective transparent adhesive layers 40 are provided between the display panel unit 30 and the transparent substrate 10 and between the transparent substrate 10 and the touch screen panel cover substrate 11.

Either one of the X axis sensing circuit portion 21 and the Y axis sensing circuit portion 22 is integrated with one surface of the touch screen panel cover substrate 11. Therefore, the raw material cost can be reduced and the optical transmittance can be improved. Furthermore, a slimmer and lighter touch screen panel can be provided.

With reference to FIG. 10, the touch sensing circuit pattern 20 includes an X axis sensing circuit portion 21 provided to one surface of the touch screen panel cover substrate 11 and including a plurality of X axis electrodes spaced from each other in the horizontal direction, and a Y axis sensing circuit portion 22 provided to the same surface of the touch screen panel cover substrate 11 and including a plurality of Y axis electrodes spaced from each other in the vertical direction.

In this touch sensing circuit pattern 20, the X axis sensing circuit portion 21 and the Y axis sensing circuit portion 22 are provided to the same surface of the touch screen panel cover substrate 11. Therefore, the raw material cost can be reduced and the optical transmittance can be improved. Furthermore, a slimmer and lighter touch screen panel can be provided.

The display panel unit 30 and the touch screen panel cover substrate 11 are bonded to each other via a transparent adhesive layer 40. An example of the transparent adhesive layer 40 may be an optically clear adhesive (OCA) film.

With reference to FIG. 11, the touch screen panel according to one embodiment of the present invention further includes a transparent substrate 10 spaced from the touch screen panel cover substrate 11. The touch sensing circuit pattern may include an X axis sensing circuit portion 21 including a plurality of X axis electrodes spaced from each other in the horizontal direction and a Y axis sensing circuit portion 22 including a plurality of Y axis electrodes spaced from each other in the vertical direction. The X axis sensing circuit portion 21 and the Y axis sensing circuit portion 22 may be formed on one surface of the transparent substrate 10.

As to the touch sensing circuit pattern 20, since the X axis sensing circuit portion 21 and the Y axis sensing circuit portion 22 are formed on the same surface of the transparent substrate 10, the raw material cost can be reduced and the optical transmittance can be improved. Furthermore, a slimmer and lighter touch screen panel can be provided.

Respective transparent adhesive layers 40 are provided between the display panel unit 30 and the transparent substrate 10 and between the transparent substrate 10 and the touch screen panel cover substrate 11.

In addition, since either one of the X axis sensing circuit portion 21 and the Y axis sensing circuit portion 22 may be integrated with one surface of the touch screen panel cover substrate 11, the raw material cost can be reduced and the optical transmittance can be improved. Furthermore, a slimmer and lighter touch screen panel can be provided.

With reference to FIG. 12, according to one embodiment of the present invention, the touch screen panel further includes a transparent substrate 10 spaced from the touch screen panel cover substrate 11. The touch sensing circuit pattern 20 may include an X axis sensing circuit portion 21 provided on one surface of the transparent substrate 10 and including a plurality of X axis electrodes spaced from each other in the horizontal direction, and a Y axis sensing circuit portion 22 provided on the other surface of the transparent substrate 10 and including a plurality of Y axis electrodes spaced from each other in the vertical direction.

Respective transparent adhesive layers 40 are provided between the display panel unit 30 and the transparent substrate 10 and between the transparent substrate 10 and the touch screen panel cover substrate 11.

Since either one of the X axis sensing circuit portion 21 and the Y axis sensing circuit portion 22 may be integrated with one surface of the touch screen panel cover substrate 11, the raw material cost can be reduced and the optical transmittance can be improved. Furthermore, a slimmer and lighter touch screen panel can be provided.

Alternatively, the X axis sensing circuit portion 21 and the Y axis sensing circuit portion 22 may be provided to respective surfaces of the transparent substrate 10. In this way, the raw material cost of a touch screen panel can be reduced and a slimmer and lighter touch screen panel can be provided.

The X axis sensing circuit portion 21 or the Y axis sensing circuit portion 22 is provided with a plurality of pores through which the transparent substrate 10 is exposed.

The X axis sensing circuit portion 21 or the Y axis sensing circuit portion 22 may include a porous electrode layer. The X axis sensing circuit portion 21 or the Y axis sensing circuit portion 22 may further include an anti-reflection layer or an adhesion-enhancing layer stacked on the electrode layer and provided with a plurality of holes communicating with the pores of the porous electrode layer.

The touch sensing circuit pattern 20 includes nanowalls 20b serving as boundary members for defining the pores and arranged in an irregular mesh form. The nanowalls 20b preferably have a line width of 50 to 3000 nm.

Since the electrode layer, the anti-reflection layer, and the adhesion-enhancing layer have been described above, a repetitive description about them will be omitted here.

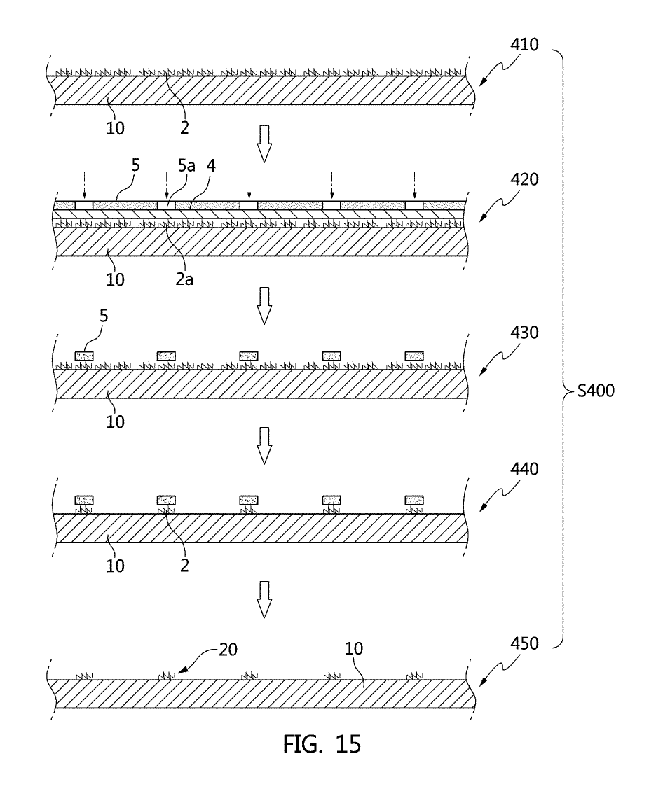

With reference to FIGS. 13 to 15, according to one embodiment of the present invention, a method for manufacturing a touch screen panel includes: forming an electrode layer 2 on a transparent substrate 10 (Step S100); forming a nanofiber layer 3 on the electrode layer 2 through an electrospinning process (Step S200); and forming a porous electrode layer provided with a plurality of pores by etching the electrode layer 2 (Step S300).

The electrode layer 2 is made from a highly conductive material, such as gold, silver, aluminum, copper, or carbon nanotubes. Alternatively, the electrode layer 2 can be made from an alloy containing at least one of gold, silver, aluminum, copper, and carbon nanotubes. The electrode layer 2 is formed to ensure a conductivity required for a touch sensing circuit pattern and have allowable resistance designed.

In Step S100 of forming the electrode layer 2, the electrode layer 2 is formed by depositing a conductive material such as gold, silver, aluminum, copper, or carbon nanotubes.

For example, the deposition is performed through a vacuum deposition process. Examples of the vacuum deposition process include thermal evaporation, ebeam deposition, laser deposition, sputtering, and arc ion plating.

In Step S100 of forming the electrode layer 2, the electrode layer 2 is formed by printing, drying, and sintering on the transparent substrate 10 a conductive paste containing conductive powder such as gold, silver, aluminum, copper, or carbon nanotubes.

When the conductive paste undergoes drying or sintering (especially sintering), resistance of the conductive paste is decreased and adhesion to the transparent substrate 10 is enhanced.

Although not illustrated, the method for manufacturing a touch screen panel according to one embodiment of the present invention may further include stacking an anti-reflection layer or an adhesion-enhancing layer on the electrode layer 2.

For example, the anti-reflection layer or the adhesion-enhancing layer can be stacked through a vacuum deposition process.

The vacuum deposition process is a process of forming the anti-reflection layer or the adhesion-enhancing layer using vacuum deposition. The vacuum deposition may be any process selected from the group consisting of thermal evaporation, ebeam deposition, laser deposition, sputtering, and arc ion plating.

In the vacuum deposition process, any one metal selected from the group consisting of chrome (Cr), molybdenum (Mo), titanium (Ti), tungsten (W), nickel-chrome (NiCr), titanium-tungsten (TiW) and copper (Cu) is used as a target material. Alternatively, an alloy containing at least two metals selected from the group molybdenum (Mo), titanium (Ti), tungsten (W), nickel-chrome (NiCr), titanium-tungsten (TiW), and copper (Cu) is used as the target material. Further alternatively, an alloy containing at least one metal selected from the group consisting of molybdenum (Mo), titanium (Ti), tungsten (W), nickel-chrome (NiCr), titanium-tungsten (TiW), and copper (Cu) is used as the target material.

As to the vacuum deposition, copper (Cu) may be preferably deposited through a thermal evaporation process. A thin deposition layer formed through copper evaporation is plating-philic whereby the thin copper deposition layer can be easily plated in the subsequent plating process Step S300. The thin copper deposition layer has high adhesion to the plating layer 2 formed in Step S300 and becomes black after the thermal deposition is performed.

The vacuum deposition process is performed in an oxygen gas ambient or a nitrogen gas ambient using the target material, thereby forming an oxide layer or a nitride layer.

The vacuum deposition process may be a process of forming an oxide layer or a nitride layer on the transparent substrate 10 by performing sputtering using a target material in an oxygen gas ambient or a nitrogen ambient, in which the target material may be a carbon material or a metal such as titanium, chrome, copper, nickel, aluminum, or silver.

The vacuum deposition process may be a process of forming an oxide layer on one surface of the transparent substrate 10 by sputtering an oxide while using an oxide such as titanium oxide (TiO2), chrome oxide (CrO2), copper oxide (CuO), nickel oxide (NiO), aluminum oxide (Al2O3), or silver oxide (AgO) as the target material. Alternatively, the vacuum deposition process may be a process of forming a nitride layer on one surface of the transparent substrate 10 by performing sputtering while using titanium nitride (TiN) or copper nitride (CuN) as the target material.

The vacuum deposition has the following advantages: securely attaching the oxide layer or the nitride layer to the transparent substrate 10; and precisely controlling the thickness of the oxide layer or the nitride layer formed on one surface of the transparent substrate 10.

The oxide layer or the nitride layer has a reflectivity of 30% or less, thereby preventing glaring attributable to reflection of electrodes and enhancing adhesion of the touch sensing circuit pattern 20 to the transparent substrate 10.

The stacking of the anti-reflection layer or the adhesion-enhancing layer includes a process of applying a conductive ink or a conductive paste on the transparent substrate 10. That is, the anti-reflection layer or the adhesion-enhancing layer can be formed with the conductive ink or the conductive paste.

The stacking of the anti-reflection layer or the adhesion-enhancing layer may further include a process of drying the conductive ink or conductive paste coated on the transparent substrate 10. Alternatively, the stacking of the anti-reflection layer or the adhesion-enhancing layer may further include a process of drying the conductive ink or conductive paste coated on the transparent substrate 10 and a process of sintering the conductive ink or conductive paste.

The applying of the conductive ink or conductive paste is, for example, a process of forming the anti-reflection layer or the adhesion-enhancing layer by printing the conductive ink or conductive paste.

The conductive ink or conductive paste may be a black ink or paste. Preferably, the anti-reflection layer or the adhesion-enhancing layer is formed with the black conductive ink or the black conductive paste to reduce diffused light.

The conductive ink or the conductive paste may contain, for example, conductive powder and a black darkening agent. The conductive powder may be any one selected from the group consisting of silver powder, copper powder, gold powder, and aluminum powder. The conductive ink or the conductive paste contains any one kind of conductive powder having a high conductivity or contains a mixture of two kinds of conductive powders.

Examples of the darkening agent include carbon black and carbon nanotube. Any material that enables the conductive ink or conductive paste to become black and have a reflectivity of 30% or less can be used for the darkening agent. Furthermore, among them, a material with a higher conductivity is more preferably adopted for the darkening agent.

The conductive ink or the conductive paste may any material containing carbon black or carbon nanotubes.

According to one embodiment of the present invention, the method for manufacturing a touch screen panel may further include curing the nanofiber layer 3 by heating the nanofiber layer 3 (Step S210).

The forming of the nanofiber layer 3 in Step S200 is a process of coating the upper surface of the electrode layer 2 with a polymer material. Specifically, by spinning the chemical resistant polymer material in the form of nanofiber using an electrospinning method, the nanofiber layer 3 is formed.

In Step S200 of forming the nanofiber layer 3, a raw material for the nanofiber layer 3 is a polymer spinning solution containing a solvent and an adhesive polymer resin such as polyvinylidene fluoride (PVDF), polystyrene (PS), poly(methylmethacrylate)(PMMA), and polyacrylonitrile (PAN).

The polymer spinning solution may further contain a resin adhesive or a surfactant.

The polymer spinning solution may contain a mixture of different polymer resins.

The polymer spinning solution may contain 5 to 20% by weight of a polymer resin and 80 to 95% by weight of a solvent, or contain 5 to 20% by weight of a polymer resin, 79.5 to 94.5% by weight of a solvent, and 0.5 to 4% by weight of a resin adhesive or a surfactant.

The resin adhesive or surfactant makes the nanofiber layer more securely adhered to the electrode layer 2, thereby facilitating formation of a metal mesh-shaped porous electrode layer when the electrode layer is etched to be the porous electrode layer.

When the porous electrode layer is formed, the electrode layer, the anti-reflection layer, or the adhesion-enhancing layer is etched away except for a portion to which the nanofiber is attached.

Therefore, it is preferable that the nanofiber layer is securely adhered to the electrode layer and is adhered over a larger area of the electrode layer.

The resin adhesive or the surfactant functions to make the nanofiber layer securely adhered to the electrode layer, and specifically enables a larger amount of the nanofiber layer to be securely adhered in an irregular arrangement, thereby improving visibility and reducing resistance of the touch sensing circuit pattern formed through the etching.

In Step S200 of forming the nanofiber layer 3, nanofiber having a diameter of 50 to 3000 nm is formed on the electrode layer 2 through an electrospinning process so that the nanofiber layer 3 can be formed on the transparent substrate 10.

In Step S210 of curing the nanofiber layer, the nanofiber layer 3 is heated to a predetermined temperature, i.e. glass transition temperature Tg at which the nanofiber made from a polymer melts, and thus a monolayer mask with a uniform thickness is formed on the electrode layer 2.

In Step S210 of curing the nanofiber layer, the nanofiber layer 3 is pressed while being heated. Through this process, the pores in the nanofiber layer 3 are uniformly distributed to form a monolayer mask.

The pressing is performed using a roller or a squeezer. The heating and pressing of the nanofiber layer 3 may be performed concurrently or successively.

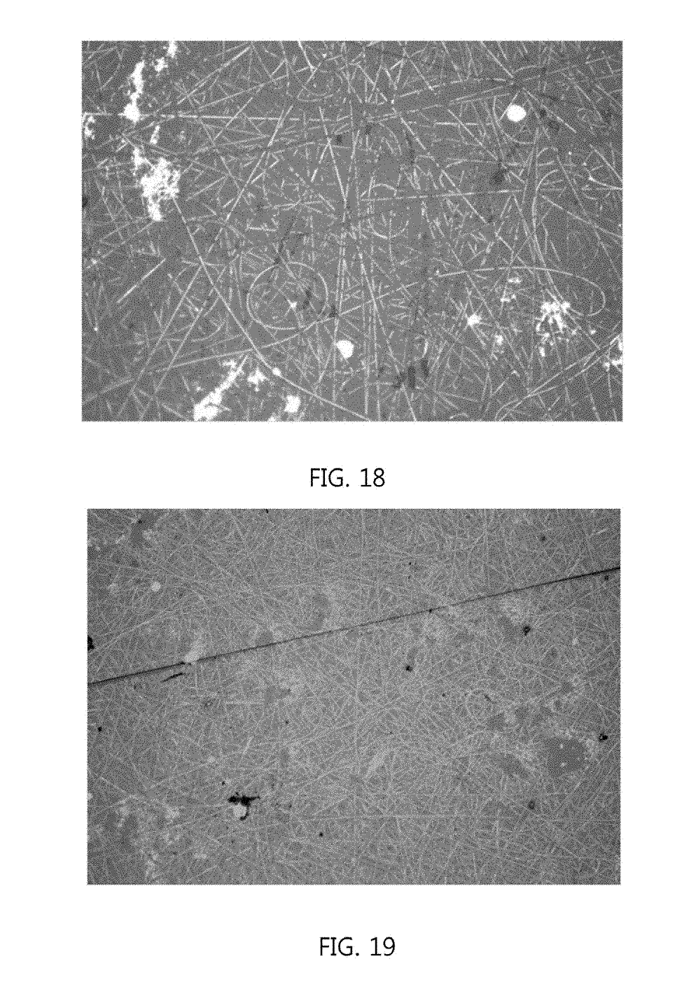

FIGS. 16 to 18 are enlarged views of the nanofiber layer. FIG. 16 is an enlarged photograph of a nanofiber layer taken by a scanning electron microscope (SEM) for a case where the nanofiber layer is formed using a polymer spinning solution containing a solvent and only PVDF.

FIG. 17 is an enlarged photograph of a nanofiber layer taken by a SEM for a case where the nanofiber layer is formed using a polymer spinning solution containing a solvent and only PAN.

FIG. 18 is an enlarged photograph of a nanofiber layer taken by a SEM for a case where the nanofiber layer is formed using a polymer spinning solution containing a solvent, PAN, and a surfactant, in which Tween 20 is used as the surfactant.

FIG. 19 is an enlarged photograph of a nanofiber layer taken by a SEM for a case where the nanofiber layer is formed using a polymer spinning solution containing a solvent, PAN, and a surfactant, in which Tween 80 is used as the surfactant.

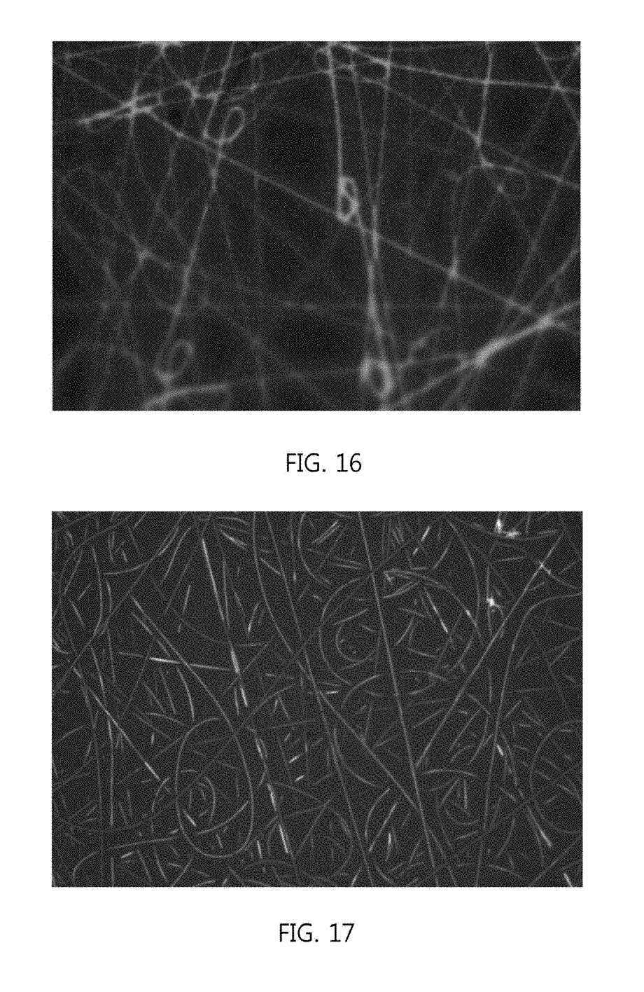

Referring back to FIGS. 14 and 15, in Step S300 of forming the porous electrode layer 2a, the electrode layer 2 is etched through openings of the mask formed by heating, melting, and curing the nanofiber layer 3. In this step, the electrode layer 2 is etched in a size of nanometers to form a plurality of nanometer-size pores.

In Step S300 of forming the porous electrode layer 2a, the nanofiber layer 3 adhered to the electrode layer 2 is used as an etching mask, so that the exposed portion of the electrode layer 2 is etched out. Thus, a plurality of pores is formed in the touch sensing circuit pattern 20 and the transparent substrate 10 is exposed through the pores.

In Step S300 of forming the porous electrode layer 2a, the electrode layer and the anti-reflection layer, or the electrode layer and the adhesion-enhancing layer are continuously etched to form the pores in the touch sensing circuit pattern 20.

Step S300 of forming the porous electrode layer 2a is also a process of forming nanowalls 20b having an irregular mesh form corresponding to the nanofiber adhered to the electrode layer, the anti-reflection layer, or the adhesion-enhancing layer. In this step, since pores are formed between the nanowalls 20b, holes can be formed in the electrode layer and the anti-reflection layer or the electrode layer and the adhesion-enhancing layer.

Step S300 of forming the porous electrode layer 2a includes a process of removing the nanofiber layer 3 after the etching is performed. After the nanofiber layer 3 is removed, irregular nanometer-size mesh patterns of the electrode layer and the antireflection layer or the electrode layer and the adhesion-enhancing layer are formed. The width of the nanowalls 20b is a nanometer-scale size corresponding to the diameter of the nanofiber and is specifically within a range of from 50 to 3000 nm.

The method of forming a touch screen panel according to one embodiment of the present invention may further include Step S400 of forming a touch sensing circuit pattern 20 by etching the porous electrode layer 2a. The touch sensing circuit pattern 20 has a predesigned pattern shape.

Step S400 of forming the touch sensing circuit pattern 20 is a process of etching the porous electrode layer 20a having an irregular mesh form to form a predesigned line pattern serving as the touch sensing circuit pattern 20.

Step S400 of forming the touch sensing circuit pattern 20 is a process of etching the irregular mesh-shaped porous electrode layer 2a and the anti-reflection layer, or the irregular mesh-shaped porous electrode layer 2a and the adhesion-enhancing layer to form a predesigned line pattern serving as the touch sensing circuit pattern 20.

With reference to FIG. 15, Step S400 of forming the touch sensing circuit pattern 20 includes: forming a photoresist layer 4 on the electrode layer 2 (Step S410);

stacking a mask 5 having an exposure pattern opening 5a corresponding to the touch sensing circuit pattern 20 on the photoresist layer 4 and exposing the photoresist layer 4 (Step S420);

developing the photoresist layer 4 to partially remove the photoresist layer 4 while leaving a portion of the photoresist layer 4 corresponding to the touch sensing circuit pattern 20 (Step S430);

forming the touch sensing circuit pattern 20 having a predesigned line pattern by performing etching, using the remaining photoresist layer 4 as an etching mask (Step S440); and

removing the photoresist layer 4 remaining on the electrode layer 2 (Step S450).

That is, Step S400 of forming the touch sensing circuit pattern 20 is a process of forming the touch sensing circuit pattern 20 by etching the electrode layer 2 using a photoresist method.

The touch sensing circuit pattern 20 may be a combination of line patterns with a line width of 15 μm or less, and preferably a combination of line patterns with a line width of 3 μm or less. The line patterns are provided with a plurality of pores through which the transparent substrate 10 is exposed. The touch sensing circuit pattern 20 includes nanowalls 20b serving as barrier members defining the pores. The nanowalls 20b have an irregular mesh form and a width of 50 to 3000 nm.

The touch sensing circuit pattern 20 has high conductivity and flexibility and is also provided with fine pores and nanowalls (i.e. barrier members for defining the pores) 20b with a width of 50 to 3000 nm, thereby dramatically improving visibility of a touch screen panel.

The pattern of an irregular mesh form solves the moire problem and the yellowing phenomenon problem of a silver nanowire.

According to the present invention, the pores formed in the circuit pattern ensure visibility and improve durability and flexibility.

Since the pattern line of the circuit pattern is irregular, the moire problem is solved and visibility is dramatically improved.

Since the touch sensor of the present invention has high conductivity, durability, and flexibility, its operation is reliable.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A touch sensor for a touch screen panel, the touch sensor comprising:
a transparent substrate; and
a touch sensing circuit pattern provided on the transparent substrate and configured to sense a touch operation applied to the touch screen panel,
wherein the touch sensing circuit pattern comprises a porous electrode layer provided with a plurality of pores.

2. The touch sensor according to claim 1, wherein the touch sensing circuit pattern comprises a line pattern having a line width of 15 μm or less, and the pores are formed within the line pattern.

3. The touch sensor according to claim 1, wherein the touch sensing circuit pattern comprises a nanowall serving as a barrier member defining the pores and having a width of 50 to 3000 nm.

4. The touch sensor according to claim 3, wherein the nanowall has an irregular mesh form in which the nanowalls are electrically connected to each other by being arranged to intersect each other.

5. The touch sensor according to claim 1, wherein the touch sensing circuit pattern further comprises an anti-reflection layer or an adhesion-enhancing layer formed on the porous electrode layer and provided with a plurality of holes communicating with the pores.

6. A method for manufacturing a touch sensor for a touch screen panel, the method comprising:
forming an electrode layer on a transparent substrate;
forming a nanofiber layer on the electrode layer through an electrospinning process; and
forming a porous electrode layer by etching the electrode layer using the nanofiber layer as an etching mask.

7. The method according to claim 6, wherein in the forming of the electrode layer, the electrode layer is formed through a vacuum deposition process.

8. The method according to claim 6, wherein in the forming of the nanofiber layer, nanofiber with a diameter of 50 to 3000 nm is formed on the electrode layer through an electrospinning process.

9. The method according to claim 6, wherein in the forming of the nanofiber layer, electrospinning is performed using a polymer spinning solution containing 5 to 20% by weight of a polymer resin and 80 to 95% by weight of a solvent.

10. The method according to claim 6, wherein in the forming of the nanofiber layer, electrospinning is performed using a polymer spinning solution containing 5 to 20% by weight of a polymer resin and 80 to 95% by weight of a solvent or a polymer spinning solution containing 5 to 20% by weight of a polymer resin, 79.5 to 94.5% by weight of a solvent, and 0.5 to 4% by weight of a resin adhesive or surfactant.

11. The method according to claim 9 or 10, wherein the polymer resin is any one selected from the group consisting of polyvinylidene fluoride (PVDF), polystyrene (PS), poly(methylmethacrylate)(PMMA), and polyacrylonitrile (PAN), or is a combination of two or more elements selected from the group.

12. The method according to claim 6, further comprising:
curing the nanofiber layer by heating the nanofiber.

13. The method according to claim 12, wherein the curing comprises pressing the nanofiber layer.

14. The method according to claim 6, further comprising:
forming a touch sensing circuit pattern by etching the porous electrode layer.
